(19) United States
(12) Patent Application Publication
(10) Pub. No.: US 2018/0235033 A1
(43) Pub. Date: Aug. 16, 2018

(54) CARTRIDGE-TYPE HEATER

(71) Applicant: TÜRK & HILLINGER GMBH, Tuttlingen (DE)

(72) Inventor: Andreas SCHLIPF, Tuttlingen (DE)

(21) Appl. No.: 15/895,326

(22) Filed: Feb. 13, 2018

(30) Foreign Application Priority Data
Feb. 14, 2017 (DE) 20 2017 100 786.3

(51) Int. Cl. H05B 3/44

(52) U.S. Cl. CPC H05B 3/44

(57) ABSTRACT

A cartridge-type heater (100, 200, 300, 400, 500) has a tubular metal sheath (110, 210, 310, 410, 510) and with an electrical heating element (222, 322, 422), which is arranged within the tubular metal sheath (110, 210, 310, 410, 510) and electrically insulated from the tubular metal sheath (110, 210, 310, 410, 510). The tubular metal sheath (110, 210, 310, 410, 510) has a first tubular part (120, 220, 320, 420, 520), in which the electrical heating element (222, 322, 422) is at least partially arranged. A tube opening (225, 325, 425) of the first tubular part is machined, especially by cutting, and has a second tubular part (130, 230, 330, 430, 530) connected to the first tubular part (120, 220, 320, 420, 520), which extends the tube interior space of the first tubular part (120, 220, 320, 420, 520) concentrically in the axial direction.

### CROSS REFERENCE TO RELATED APPLICATIONS

This application claims the benefit of priority under 35 U.S.C. § 119 of German Application 20 2017 100 786.3, filed Feb. 14, 2017, the entire contents of which are incorporated herein by reference.

### FIELD OF THE INVENTION

The present invention pertains to a cartridge heater (a cartridge-shaped heater or cartridge-type heater) with a tubular metal sheath and with an electrical heating element, which is arranged within the tubular metal sheath and electrically insulated from the tubular metal sheath.

### BACKGROUND OF THE INVENTION

Cartridge-type heaters are known and widely used electrical heating devices, in which the electrical heating element, e.g., a coiled resistance wire as a heating coil or, e.g., a heating wire wound onto a coil body made of ceramic, is arranged within a tubular metal sheath and electrically insulated from the tubular metal sheath, e.g., by embedding into an insulating material filling.

It is important for some applications of such cartridge-type heaters to be able to predefine an exact positioning and/or orientation of the cartridge-type heater. It has been known up to now to make such a positioning possible by a thread arranged on the tubular metal sheath, as described in DE 29 35 430 A1, by a union nut provided with a thread, as described in DE 23 47 090, or by welding on a thread nipple, as is known from cartridge-type heaters from the product range of the applicant. It has been shown, however, that these solutions no longer sufficiently meet the ever increasing demands for process reliability.

### SUMMARY OF THE INVENTION

An object of the invention is to provide a cartridge-type heater, which can be dimensioned, oriented and positioned for a reliable process.

The cartridge-type heater according to the present invention has a tubular metal sheath and an electrical heating element, which is arranged within the tubular metal sheath and is electrically insulated from the tubular metal sheath. In this case, it is essential to the present invention that the tubular metal sheath have a first tubular part, in which the electrical heating element is at least partially, but preferably completely arranged, and have a second tubular part, which is connected to the first tubular part and which extends the tube interior space of the first tubular part, or the first tubular part in a preferred embodiment, concentrically in the axial direction. In this case, a tube opening of the first tubular part, especially the tube opening on the connection side, is machined, especially machined by cutting.

Such a splitting of the tubular metal sheath of the cartridge-type heater especially makes it possible to provide means for the positioning and orientation of the cartridge-type heater at a section of the tubular metal sheath which is no longer deformed during the production of the cartridge-type heater, e.g., during the compaction, and the arrangement thereof is correspondingly no longer influenced, which advantageously influences the achievable process reliability. Because the tube opening of the first tubular part, which is facing the second tubular part and to which the second tubular part is connected, was subjected to machining, especially to machining by cutting, possible deformations that develop during the compaction, are also eliminated within the framework of this machining, so that the dimensions of the finished cartridge-type heater are much better defined than this was the case up to now.

It is especially preferred here that the first tubular part and the second tubular part are aligned with one another in order to provide, as a result, a cartridge-type heater, which hardly differs geometrically from the prior-art cartridge-type heaters with a one-piece tubular sheath.

It is especially preferred if possible radial projections outwards or inwards of the tube sheaths of the first and second tubular parts are smaller than the thickness of the tube sheath of the first tubular part. It is especially preferred if there are no radial projections outwards and/or inwards between the first and second tubular parts. In other words, the step in case of the transition between the outer contour and/or inner contour of the first tubular part to the outer contour and/or inner contour of the second tubular part is limited by the thickness of the tube sheath of the first tubular part upwards and a stepless transition is especially preferred.

It is especially preferred if an electrical connection is arranged in the interior, more specifically only in the interior, of the second tubular part between the electrical heating element and an electrical conductor of a supply line for supplying the electrical heating element with current. This makes it possible to establish this connection only after finishing the heated part of the cartridge-type heater and then subsequently to incorporate it into the tubular metal sheath by connecting the first tubular part and the second tubular part, which leads to a significant increase in process reliability in terms of the connection quality of the electrical connection. As an alternative to this, it is, of course, also possible to establish an electrical connection entirely outside of the first second tubular part and of the second tubular part in order to establish the electrical connection only after finishing the heated part of the cartridge-type heater.

In an especially preferred variant of the present invention, the second tubular part has a machined tube opening as well, wherein the machined tube opening of the first tubular part and the machined tube opening of the second tubular part are facing one another and are machined complementary to one another, so that a high reproducibility of the arrangement of the first tubular part at the second tubular part is achieved. In this connection, it is especially preferable if the machined tube opening of the first tubular part and the machined tube opening of the second tubular part are configured complementary to one another such that a connection between the first tubular part and the second tubular part is brought about in the correct position and/or in the correct location.

The structural weakening of the tubular metal sheath of the cartridge-type heater due to its splitting into two parts can be compensated or even overcompensated by the machined tube opening of the first tubular part and the machined tube opening of the second tubular part being configured complementary to one another such that a transmission of forces and/or torques between the first tubular part and the second tubular part is made possible.

The complementarity of the tube opening of the first tubular part and/or of the tube opening of the second tubular part to the respective other tube opening can especially be generated by machining by cutting, e.g., turning or milling.

An embodiment, in which the tube openings, which are machined complementary to one another, form a defined tolerance pairing, is preferred here. Due to such a defined fit with little or no play of the machined tube openings, the warping in subsequent processing operations, e.g., when the first tubular part shall be welded together with the second tubular part, can be minimized, which then improves the alignment of these parts and there is especially no radial projection.

It is especially preferable for this if the first tubular part has a conically turned tube opening and that the tube opening of the second tubular part facing the tube opening of the first tubular part has an inner cone configured complementary thereto. It is especially preferable in this case that the cone ratio of the conically machined tube openings is selected such that a self-locking occurs, which is the case, e.g., at a ratio of 1:50.

The connection between the first tubular part and the second tubular part is preferably established by the tube openings, which are machined complementary to one another, being connected to one another and/or welded, soldered or bonded together with one another by a transition fit, a press fit or a force fit.

In a preferred variant of the present invention, different types of cartridge-type heaters, possibly different heat outputs, are made identifiable by their first tubular parts being equipped with tube openings, which have each been machined differently.

The present invention is explained in greater detail below on the basis of the figures, which show exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is an external view of a cartridge-type heater according to the present invention;

FIG. 1b is a partial exploded view of the cartridge-type heater from FIG. 1a;

FIG. 2a is a sectional view of a first possible variant of an internal structure of a cartridge-type heater before assembly;

FIG. 2b is the cartridge-type heater from FIG. 2a after assembly;

FIG. 3a is a sectional view of a second possible variant of an internal structure of a cartridge-type heater before assembly;

FIG. 3b is the cartridge-type heater from FIG. 3a after assembly;

FIG. 4 is a sectional view of a third possible variant of an internal structure of a cartridge-type heater;

FIG. 5a is a view of another embodiment of a cartridge-type heater before assembly in a first perspective;

FIG. 5b is a view of the cartridge-type heater from FIG. 5a in a second perspective; and

FIG. 5c is a variant for the second tubular part of the cartridge-type heater shown in FIGS. 5a and 5b.

### DESCRIPTION OF THE PREFERRED EMBODIMENTS

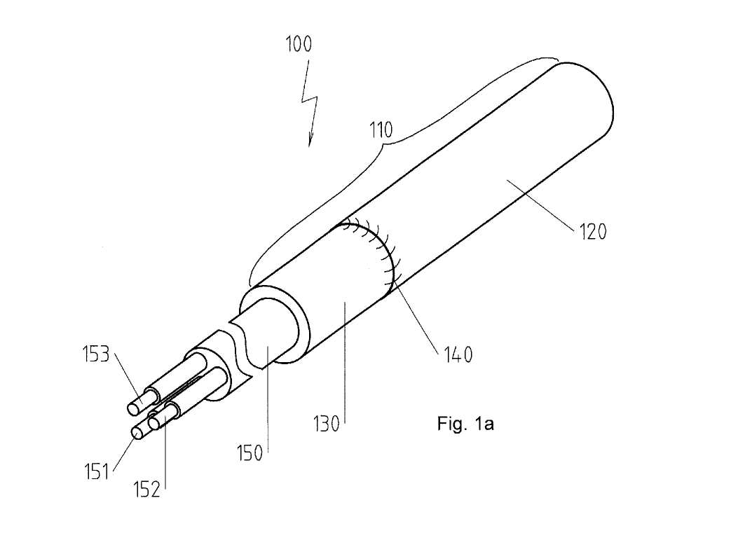

Referring to the drawings, FIG. 1a shows an external view of an electrical cartridge-type heater 100. It can be seen in this external view that the electrical cartridge-type heater 100 has a tubular sheath 110, which is composed of a first tubular part 120 and a second tubular part 130, which extends the first tubular part 120 concentrically, which parts are connected to one another with a welded connection 140. A supply line 150, which is shown partially opened, leads into the second tubular part 130 in order to show the electrical conductors 151, 152, 153.

The concrete manner, in which this connection is obtained between the first tubular part 120 and the second tubular part 130 in perfect orientation even if the first tubular part 120 was compacted, can be seen particularly well in the partial exploded view of FIG. 1b, in which these parts are shown separated from one another. The connection sections 123, 124 of the heating element of the compacted structure, which is found within the first tubular part 120, are inserted into an optional connection element 160 and connected in an electrically insulating manner to connection sections of the conductors 151, 152 of the supply line 150. The conductor 153 is a ground conductor, with which the second tubular part 130 is grounded. In the assembled end state, electrical contacts to the heating element are correspondingly only obtained in the second tubular part 130.

The first tubular part 120 has a collar 128, which was produced by machining by cutting, on its tube opening on the connection side. The inner diameter of the second tubular part 130 in the area of the tube opening facing the first tubular part 120 is adapted complementary thereto, so that the second tubular part 130 can be pushed without play onto the collar 128 of the first tubular part 120 and can be fastened to it. While this adaptation can, in principle, be obtained by the second tubular part having a smaller thickness of the tube sheath, i.e., its wall, it is preferred if the first tubular part 120 and the second tubular part 130 have tube sheaths of identical thickness and the inner diameter of the second tubular part 130 in the area of the tube opening facing the first tubular part 120 is enlarged by machining by cutting, so that an exactly fitting pushing without play onto the collar 128 is possible.

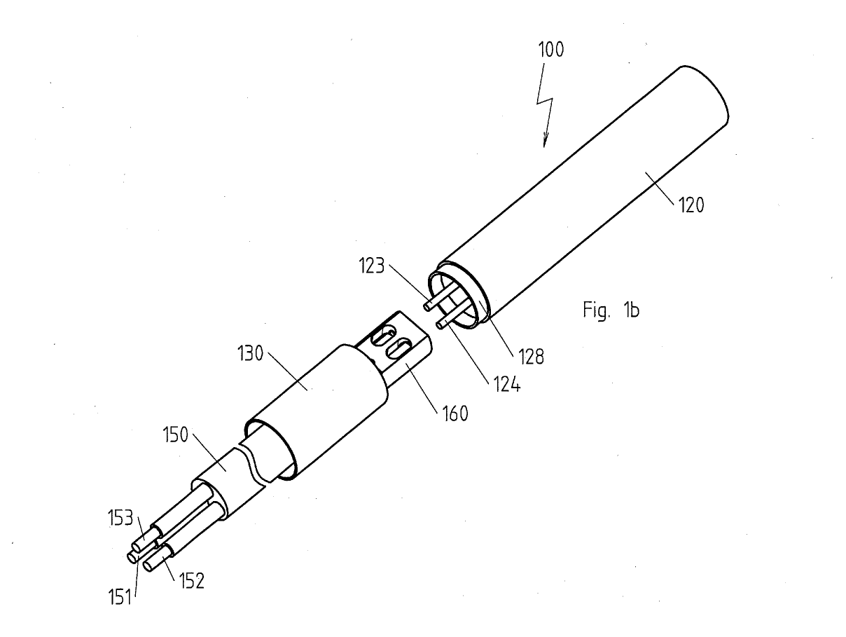

The sectional views of FIGS. 2a and 2b show another possible internal structure of a cartridge-type heater 200 configured according this basic principle, the tubular metal sheath 210 of which is composed of a first tubular part 220 and a second tubular part 230. In the section of the interior space 226 of the first tubular part 220, which is filled with an electrical insulating material, e.g., MgO, is arranged a coil body 221, which is wound with an electrical heating element 222, which is configured as a heat conductor, wherein it is ensured by the electrical insulating material that the electrical heating element 222 is electrically insulated from the tubular metal sheath 210. Connection sections 223, 224 of the heat conductor, which may, as an alternative, also be configured as connection wires, which are in electrical contact with the heat conductor 222, protrude from the tube opening 225 of the first tubular part 220. In the assembled end state, electrical contacts to the heating element 222 are correspondingly preferably only formed in the second tubular part 230 in the cartridge-type heater 200 shown.

A supply line 250, which is shown only in some sections in FIG. 2a, with electrical conductors 241, 242, which are crimped via cable lugs 253, 254 with the connection sections 223, 224 of the heat conductor 222, but may also be connected to one another in an electrically insulating manner in a different way, e.g., by soldering or welding, is inserted into the interior space 232 of the second tubular part 230 through an insertion opening 233, while the second tubular part 230 is threaded onto the supply line 250, but is not yet connected (as in FIG. 2b) to the second tubular part. The electrical connection thus established can thus be established and checked by inspection, on the one hand, but is then reliably securely arranged in the interior of the tube sheath 210.

For assembling the tube sheath 210 from the first tubular part 220 and the second tubular part 230, the interior space of the tube opening 225 is milled to a fit size, so that a recess 227 is formed. The second tubular part 230 has a tube opening 231 facing the tube opening 225 of the first tubular part 220, which tube opening 231 has a turned collar 234, which is adapted to the recess 227 in an exactly fitting manner, so that the tube openings 225 and 231 are machined complementary to one another and can be assembled without play, as is shown in FIG. 2b. In the assembled state, they can then be welded together with one another with a weld seam 240, e.g., as shown.

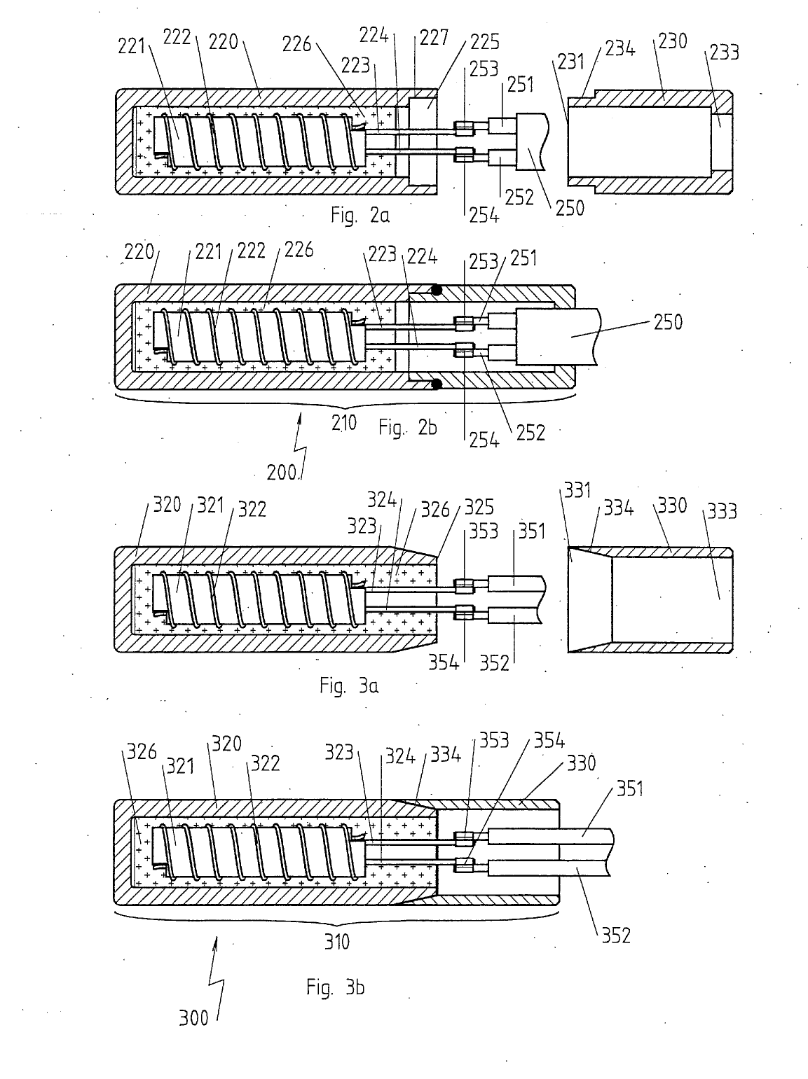

The sectional views of FIGS. 3a and 3b show a second variant of a possible internal structure of a cartridge-type heater 300 configured according to this basic principle, the tubular metal sheath 310 of which is composed of a first tubular part 320 and a second tubular part 330. In the section of the interior space 326 of the first tubular part 320, which section is filled with an electrical insulating material, e.g., MgO, is arranged a coil body 321, which is wound with an electrical heating element 322 configured as a heat conductor, wherein it is ensured by the electrical insulating material that the electrical heating element 322 is electrically insulated from the tubular metal sheath 310. Connection sections 323, 324 of the heat conductor, which may, as an alternative, also be configured as connection wires, which are in electrical contact with the heat conductor 322, protrude from the tube opening 325 of the first tubular part 320.

Electrical conductors 351, 352, which are shown only in some sections in FIG. 3a, which form supply lines, which are crimped via cable lugs 353, 354 with the connection sections 323, 324 of the heat conductor 322, but may also be connected to one another in an electrically insulating manner in a different way, e.g., by soldering or welding, are inserted into the interior space 332 of the second tubular part 330 through an insertion opening 333, while the second tubular part 330 is threaded onto the electrical conductors 351, 352, but is not yet connected to the second tubular part (as in FIG. 2b). The electrical connection thus established may thus be established and checked by inspection, on the one hand, but is then arranged securely in the interior of the tube sheath 310. In addition, since the insertion opening 333 in this exemplary embodiment has a larger configuration, the entire arrangement can still be further protected by an optional filling in of the remaining interior space of the second tubular part 330 after assembly. Correspondingly, electrical contacts to the heat conductor 322 are thus again preferably only obtained in the second tubular part 330 in the assembled end state in the cartridge-type heater 300 shown.

For assembling the tube sheath 310 from the first tubular part 320 and the second tubular part 330, the outer surface of the tube opening 325 is conically turned, e.g., with a cone ratio of 1:50. The second tubular part 330 has a tube opening 331 facing the tube opening 325 of the first tubular part 320, which tube opening 331 has an inner cone 334 complementary to it, so that the first tubular part 320 and the second tubular part 330 can be assembled without play in a conical force fit. and is adapted, so that the tube openings 325 and 331 are machined complementary to one another and can be assembled without play, as is shown in FIG. 3b. In the assembled state, they may optionally be welded together with one another if the strength of the connection shall be even higher, which may especially ensure an improved absorption of torsional loads.

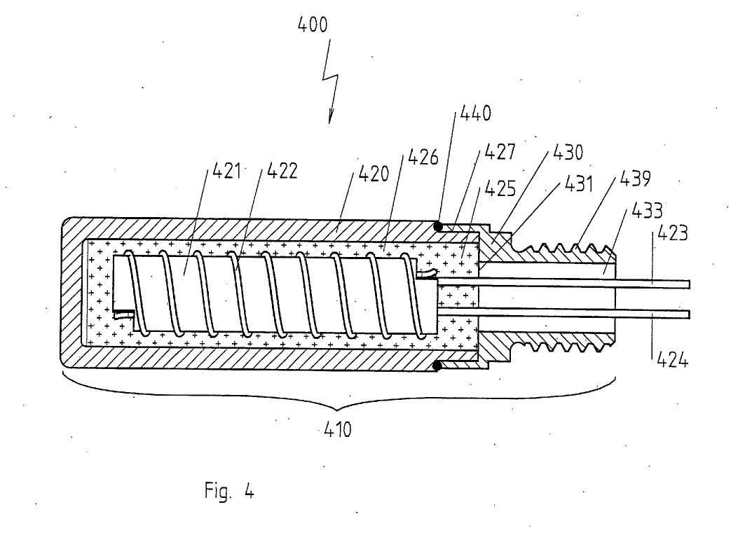

The exemplary embodiment of an electrical cartridge-type heater 400 shown in FIG. 4, the tubular metal sheath 410 of which is composed of a first tubular part 420 and a second tubular part 430 is, differs from the exemplary embodiment of FIGS. 2a and 2b essentially by the configuration of the connection between the first tubular part 420 and the second tubular part 430, which is, in addition, provided with an external thread 439.

A coil body 421, which is wound with an electrical heating element 422 that is configured as a heat conductor, is arranged in the section of the interior space 426 of the first tubular part 420, which section is filled with an electrically insulating material, e.g., MgO, and it is ensured by the electrically insulating material that the electrical heating element 422 is electrically insulated from the tubular metal sheath 410. Connection sections 423, 424 of the conductor, which may, as an alternative, be configured as connection wires, which are in electrical contact with the heat conductor 422, protrude from the tube opening 425 of the first tubular part 420 and further lead through the interior space 432 of the second tubular part 430 and through an opening 433.

For assembling the tube sheath 410 from the first tubular part 420 and the second tubular part 430, the interior space of the tube opening 431 of the second tubular part 420 is milled to a fit size. The first tubular part 420 has a tube opening 425 facing the tube opening 431 of the second tubular part 430, which tube opening 425 has a turned collar 427, which is adapted in an exactly fitting manner to the milled recess in the tube opening 431 of the second tubular part 425, so that the tube openings 425 and 431 are machined complementary to one another and can be assembled without play, as is shown in FIG. 4. In the assembled state, they can then be welded together with one another with a weld seam 440, e.g., as shown.

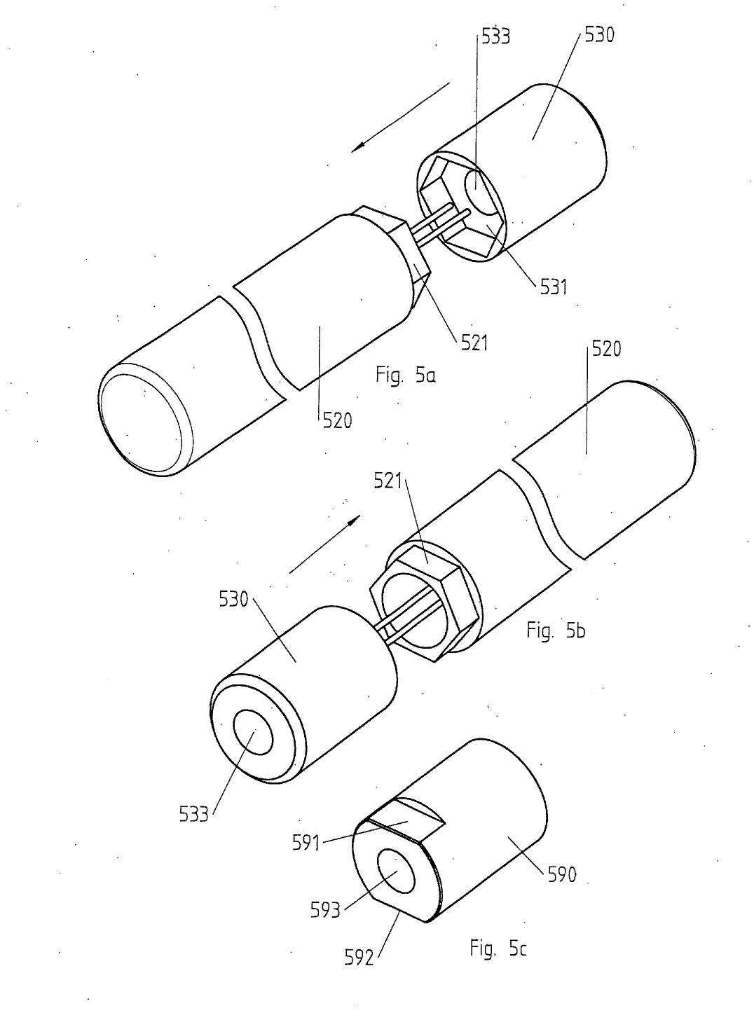

In the cartridge-type heater 500 which is shown in FIGS. 5a and 5b with a tube sheath 510, which is composed of a first tubular part 520 and a second tubular part 530, the internal structure can be configured, for example, as in FIG. 4. The essential additional feature is that here at the first tubular part 520 is provided a collar with a hexagonal configuration, which collar can be inserted into a hexagonal recess 531 complementary to it, the bottom of which recess passes into a through opening 533, at the second tubular part. On the one hand, the orientation of the first tubular part 520 is thereby more accurately predefined; on the other hand, it is possible in this embodiment to transmit high torsional forces between the first tubular part 520 and the second tubular part 530 as well.

As can be seen in the alternative exemplary embodiment of such a second tubular part 530 shown in FIG. 5c, an attachment for a tool can then be provided, e.g., by providing contact surfaces 592, with which tool, e.g., screwing in of a cartridge-type heater becomes possible, without there being a risk that the heated section of the cartridge-type heater, which heated section is arranged in the first tubular part of the metal sheath, is damaged due to forces exerted by the tool.

While specific embodiments of the invention have been shown and described in detail to illustrate the application of the principles of the invention, it will be understood that the invention may be embodied otherwise without departing from such principles.

What is claimed is:

1. A cartridge heater comprising:
a tubular metal sheath;
an electrical heating element arranged within the tubular metal sheath and electrically insulated from the tubular metal sheath, wherein:
the tubular metal sheath has a first tubular part, in which the electrical heating element is at least partially arranged and has a second tubular part;
a tube opening of the first tubular part is machined by cutting; and
the second tubular part is connected to the first tubular part and extends the tube interior space of the first tubular part concentrically in an axial direction.

2. A cartridge heater in accordance with claim 1, wherein the first tubular part and the second tubular part are aligned with one another.

3. A cartridge heater in accordance with claim 1, wherein no projection in the radial direction inwards and/or outwards or a projection, which is smaller than the thickness of the tube sheath of the first tubular part, is present between the first tubular part and the second tubular part.

4. A cartridge heater in accordance with claim 1, further comprising:
an electrical connection arranged in the interior of the second tubular part between the electrical heating element; and
an electrical conductor of a supply line for supplying the electrical heating element with current.

5. A cartridge heater in accordance with claim 1, wherein:
the second tubular part has a machined tube opening;
the machined tube opening of the first tubular part and the machined tube opening of the second tubular part face one another and are machined complementary to one another.

6. A cartridge heater in accordance with claim 5, wherein the machined tube opening of the first tubular part and the machined tube opening of the second tubular part are configured complementary to one another such that a connection between the first tubular part and the second tubular part is brought about in a correct position or in a correct location or both in a correct position and in a correct location.

7. A cartridge heater in accordance with claim 5, wherein the machined tube opening of the first tubular part and the machined tube opening of the second tubular part are configured complementary to one another such that a transmission of forces, between the first tubular part and the second tubular part, is made possible or a transmission of torques, between the first tubular part and the second tubular part, is made possible or both a transmission of forces and a transmission of torques, between the first tubular part and the second tubular part, is made possible.

8. A cartridge heater in accordance with claim 5, wherein:
the complementarity of the tube opening of the first tubular part to the respective other tube opening is generated by machining by cutting; or
the complementarity of the tube opening of the second tubular part to the respective other tube opening is generated by machining by cutting; or
the complementarity of the tube opening of the first tubular part to the respective other tube opening is generated by machining by cutting and the complementarity of the tube opening of the second tubular part to the respective other tube opening is generated by machining by cutting.

9. A cartridge heater in accordance with claim 5, wherein the tube openings, which are machined complementary to one another, form a defined tolerance pairing.

10. A cartridge heater in accordance with claim 5, wherein:
the first tubular part has a conically turned tube opening; and
the tube opening of the second tubular part facing the tube opening of the first tubular part has an inner cone configured complementary to the conically turned tube opening of the first tubular part.

11. A cartridge heater in accordance with claim 10, wherein the cone ratio of the conically machined tube openings is selected such that a self-locking occurs.

12. A cartridge heater in accordance with claim 5, wherein the tube openings, which are machined complementary to one another, are connected to one another or welded together with one another by a transition fit, a press fit or a force fit.

13. A cartridge heater in accordance with claim 1, wherein a type of machining of the tube opening of the first tubular part provides a code as to a type of the cartridge heater.
